(19) United States
(12) Patent Application Publication
(10) Pub. No.: US 2003/0030925 A1
(43) Pub. Date: Feb. 13, 2003

(54) Movable mirror driving mechanism for bar code reader

(76) Inventors: Keigo Suzuki, .Fukushima (JP); Hidekuni Aizawa, Kanagawa (JP)

Correspondence Address: Robert J. Depke, Holland & Knight LLP, Suite 800, 55 West Monroe Street, Chicago, IL, 60603-5144, US

(21) Appl. No.: 10/192,238

(22) Filed: Jul. 10, 2002

(30) Foreign Application Priority Data
Jul. 16, 2001 (JP) JP2001-214902

(51) Int. Cl. G02B 7/182

(52) U.S. Cl. 359/877

(57) ABSTRACT

Disclosed is a movable mirror driving mechanism for bar code reader capable of optimizing the coil as a whole as compared to a conventional single coil commonly used for driving and electromotive force detection purposes. The movable mirror driving mechanism for bar code reader is a type in which the laser beam emitted from the light emitting element is reflected by the movable mirror, the movable mirror is oscillated to make the laser beam scan across the object to be scanned and ight returned from the object to be scanned is reflected off the movable mirror to be received by the light receiving element. The movable mirror driving mechanism for bar code reader comprises the movable mirror supported to oscillated about the pivot, the magnetic member firmly attached to the movable mirror and the coil interlinking with magnetic flux of the magnetic member. The coil is a dual coil comprising the driving coil for oscillating the movable mirror and the electromotive force detection coil integrally wound with the driving coil and having a smaller wire diameter and a larger number of turns than the driving coil.

### CROSS REFERENCES TO RELATED APPLICATIONS

The present document is based on Japanese Priority Document JP 2001-214902, filed in the Japanese Patent Office on Jul. 16, 2001, the entire contents of which being incorporated herein by reference.

### BACKGROUND OF THE INVENTION

1. Field of Invention

The present invention relates generally to a movable mirror driving mechanism for bar code reader for scanning a bar code pattern, that is, an object to be scanned, by a laser beam emitted from a light emitting element, more specifically to an improved technology for efficiently driving a coil for such movable mirror.

2. Description of Related Art

Recently, sales management of goods in many stores and production control of products in many plants are generally made by optically reading out digital information of bar codes attached to the goods or products. Typically, such bar codes are read out by irradiating a light beam onto and across the bar codes and converting the intensity of the reflected light beam into corresponding electrical signals by a photoelectric converter, thereby reading the information based on combinations of the detected signals.

As illustrated in a conceptual representation of FIG. 4, a light projection lens 3 focuses a beam of light emitted from a light emitting element 1. The light beam is, then, reflected off a mirror 7 of a scanning mirror (movable mirror) 5 and is directed onto a bar code pattern 9 of an object to be scanned. In order to direct the light across the entire area of the bar code pattern 9, the mirror 7 is oscillated. Such oscillation is achieved by placing a magnetic member (magnet) 11 attached to the mirror 7 in a driving coil 13. An electrical current alternating, between positive and negative directions at a constant frequency is made to flow through the driving coil 13 which attracts and repels the magnet 11. As a result, the mirror 7 is oscillated about a pivot 15.

On the other hand, the light directed onto the bar code pattern 9 causes diffused reflection and partly returns back to the mirror 7 with different light amount depending on the black and white pattern of the bar code. A condenser lens 17 collects such varying reflected light before a light receiving element 19 converts the reflected light into the corresponding electrical. It is to be noted that a band pass filter (BPF) 21 is disposed in front of the light receiving element 19 in order to improve reading accuracy by eliminating unnecessary light components other than the frequency of the emitted light.

Illustrated in FIG. 5 is a movable mirror driving mechanism for bar code reader exemplifying the reading apparatus as described hereinabove. In the illustrated present example, the movable mirror driving mechanism comprises a movable mirror 5 installed in a housing 23 in an oscillating manner, the magnet 11 firmly attached to the movable mirror 5, the driving coil 13 for developing magnetic force to be exerted onto the magnet 5 for oscillating the movable mirror 5, an opening 25 for allowing the laser beam from the light emitting element 1 and reflected by the movable mirror 5 to travel outside the housing 23 and also allowing the light from the bar code pattern 9 to return inside the housing 23, and the light receiving element 19 for receiving the returned light. A bar code reader is completed by accommodating the housing 23 in a frame (not shown).

As described above, the movable mirror driving mechanism is capable of oscillating the movable mirror by supplying an alternating electrical current (e.g., of about 20 Hz) through the driving coil. Incidentally, the oscillating system of the movable mirror has its inherent resonance frequency. This means that the movable mirror can be oscillated with the minimum energy or most efficiently if driven at the resonance frequency. Unfortunately, however, even if design conditions of the oscillating system of the movable mirror may be set to have the resonance frequency of, e.g., 20 Hz, it is most likely that the actual resonance frequency is shifted from the intended resonance frequency because of mechanical loss such as, e.g., mass balance and friction resistance of the oscillating system. If the oscillating system is driven at a designed frequency other than the resonance frequency, it encounters problems such as requiring additional driving energy, unstable oscillating operation and oscillating the movable mirror at abnormal angles. Under such circumstance, scanning on the bar codes becomes unstable and the reading of the bar codes becomes less accurate.

A typical solution to such problem is to detect counter electromotive force caused by the relative movement of the driving coil and the magnet as shown in FIG. 6. The driving frequency of the movable mirror is obtained from the counter electromotive force and the driving control to flow the driving current through the driving coil is made in response to the oscillation condition of the movable mirror. A conventional detection of the counter electromotive force for such control is made using a single driving coil as shown in FIG. 7. In other words, a single coil is commonly used as the driving coil and for detection of the driving frequency.

Such common use of a single coil for the dual purposes helps miniaturization. However, the number of turns required for detecting the counter electromotive force is several times larger than the number of turns needed for driving. This means that, in order to use a single coil for the above two purposes, the coil must have at least the turns necessary for detecting the counter electromotive force, which is too many to obtain the required driving force. Also, sharing a single coil prevents selection of optimum wire diameters for respective purposes, thereby restricting optimization of the coil and disabling to improve efficiency of the coil.

### SUMMARY OF INVENTION

In consideration of the drawbacks of the conventional technology, there is a need for a movable mirror driving mechanism for bar code reader capable of optimizing the entire coil as compared to the case of common use of a single coil for both driving and electromotive force detection purposes.

It is therefore one aspect of the present invention to provide a movable mirror driving mechanism for bar code reader in which a laser beam emitted form a light emitting element is reflected by a movable mirror, the laser beam scans across an object to be scanned and a return beam from the object to be scanned is reflected off the movable mirror so that it is received by a light receiving element. It features in the provision of the movable mirror supported to be oscillated about a pivot, a magnet firmly attached to the movable mirror, and a coil interlinking with magnetic flux of the magnet, wherein the coil is a dual coil of a driving coil for driving the movable mirror and an electromotive force detection coil integrally wound with the driving coil using a smaller diameter wire than the driving coil and having a larger number of turns than the driving coil

The use of the dual coil of the above-described arrangement helps to optimize the respective coils for different purposes in the movable mirror driving mechanism for bar code reader. In other words, the driving coil has a smaller number of turns and a larger wire diameter than the electromotive force detection coil to provide a larger driving force by supplying a larger driving force. On the other hand, the electromotive force detection coil can use a smaller diameter wire and a larger number of turns than the driving coil to obtain a large electromotive force. As a result, any waste of the coil in the conventional technology is avoided, thereby achieving high efficiency and miniaturized coils as a whole.

The movable mirror driving mechanism for bar code reader according to another aspect of the present invention is characterized in that the driving coil is wound outside the electromotive force detection coil. As mentioned above, the electromotive force detection coil requires a larger number of turns than the driving coil necessary to detect the electromotive force. Therefore, the electromotive force detection coil according to the present embodiment, which is wound at an inner position where higher detection efficiency is available, that is, at a position inner than the driving coil, can have reduced number of turns. In other words, the total volume occupied by the coils can be reduced as compared to the case of winding the driving coil inside the electromotive force detection coil, thereby miniaturizing the entire dual coil.

Another aspect of the movable mirror driving mechanism for bar code reader according to the present invention is the type in which a laser beam emitted from a light emitting element is reflected off a movable mirror, the mirror is oscillated to scan the laser beam across an object to be scanned and a returned beam from the object to be scanned is reflected off the movable mirror to be received by a light receiving element. It features in comprising the movable mirror supported to oscillate about a pivot, a magnet firmly attached to the movable mirror, and a coil interlinking with magnetic flux of the magnet, wherein the coil is formed with a center tap acting as a boundary to separate into a driving coil for oscillating the movable mirror and an electromotive force detection coil.

In the movable mirror driving mechanism for bar code reader as described above, the coil interlinking with magnetic flux of the magnet provided with the center tap is separated into the driving coil for oscillating the movable mirror and the electromotive force detection coil, thereby enabling to optimize the number of turns of the coils for the respective purposes. That is, the driving coil has a smaller number of turns than the electromotive force detection coil but is designed to supply a larger current to provide a larger driving force. On the other hand, the electromotive force detection coil has a larger number of turns than the driving coil to obtain a large electromotive force. Such particular configuration enhances the efficiency of the coil as compared to the conventional single coil commonly used for the two purposes. Additionally, it is possible to continuously wind a single diameter wire to have optimum number of turns necessary for the intended purpose at both sides of the center tap.

### BRIEF DESCRIPTION OF DRAWINGS

The above and other objects, features and advantages of the present invention will become more apparent from the following description of the presently preferred exemplary embodiments of the invention taken in conjunction with the accompanying drawings, in which:

FIG. 1 is a cross section view of a movable mirror driving mechanism for bar code reader according to the present invention;

FIG. 2 is a magnified cross section view of the coil in FIG. 1;

FIG. 3 shows a waveform of electromotive force detected by an electromotive force detection coil;

FIG. 4 is a conceptual representation to describe a conventional optical reading configuration;

FIG. 5 is a cross section view of a conventional movable mirror driving mechanism for bar code reader;

FIG. 6 shows a waveform of counter electromotive force detected by a common coil; and

FIG. 7 is a cross section view of the coil in FIG. 6.

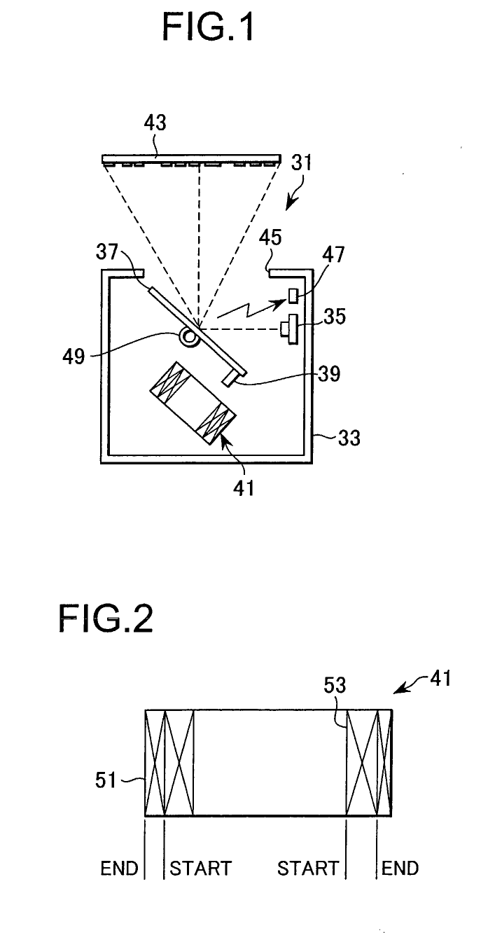

### DESCRIPTION OF PREFERRED EMBODIMENT

Now, preferred embodiments of the movable mirror driving mechanism for bar code reader according to the present invention will be described in detail with reference to the attached drawings.

An embodiment of the movable coil driving mechanism 31 for bar code reader according to the present invention comprises a housing 33, a light emitting element 35 disposed in the housing 33, a movable mirror 37 installed in the housing 33 in an oscillating manner, a magnet 39 made of a magnetic member firmly attached to the movable mirror 37, a coil 41 for oscillating the movable mirror 37 by magnetic interaction with the magnet 39, an opening 45 through which a laser beam emitted from the light emitting element 35 and reflected by the movable mirror 37 is made travel outside the housing 33 and the light reflected off a bar code 43 on an object to be scanned returns into the housing 33 and a light receiving element 47 for receiving the returned light from the movable mirror 37.

The movable mirror 37 is designed to oscillate about a pivot 49. The magnet 39 firmly attached to the movable mirror 37 develops magnetic flux to interlink with the coil 41. As a result of oscillating the movable mirror 37, the magnetic flux varies in the coil 41, thereby inducing electromotive force in the coil 41. The magnitude of the electromotive force is proportional to the product of a rate of change of the magnetic flux interlinking with the coil 41 and the number of turns of the coil 41.

As shown in FIG. 2, the coil 41 is a dual coil comprising a driving coil 51 for oscillating the movable mirror and an electromotive force detection coil 53. The electromotive force detection coil 53 is integrally wound with the driving coil 51 and has a smaller wire diameter and a larger number of turns than the driving coil 51. It is to be noted that the coil 41 of the present embodiment is a double layer coil, in which the driving coil 51 is wound outside the electromotive force detection coil 53.

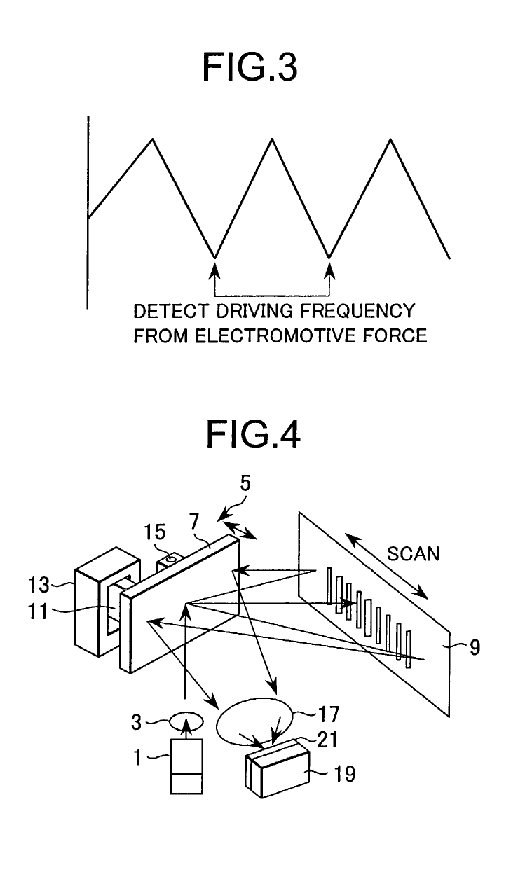

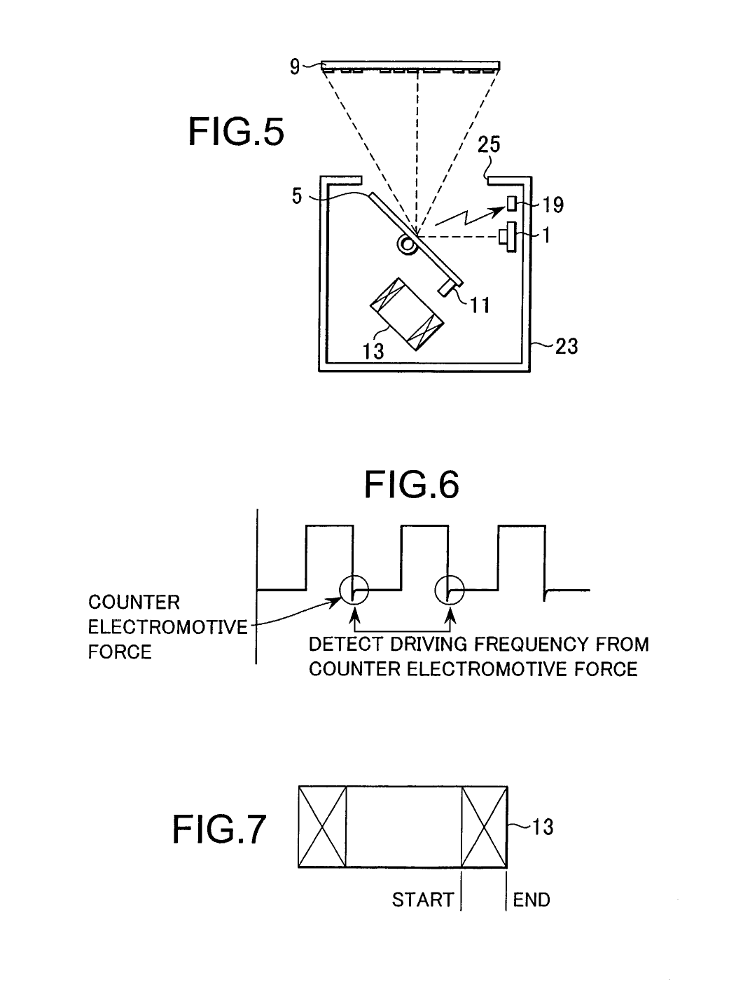

In the movable mirror driving mechanism 31 for bar code reader, upon supplying, e.g., positive and negative currents (alternating current) at a fixed interval in the driving coil 51, the magnet 39 is attracted and repelled with respect to the driving coil 51, thereby oscillating the movable mirror about the pivot 49. Simultaneously, such oscillation of the movable mirror 37 causes change in magnetic flux interlinking with the coil 41, thereby inducing electromotive force in the electromotive force detection coil 53. FIG. 3 shows a waveform of the electromotive force. It is possible to obtain from the waveform of the detected electromotive force the driving frequency, i.e., the inherent resonance frequency of the movable mirror 37.

The movable mirror diving mechanism 31 for bar code reader is controlled by control means (not shown) based on the driving frequency in the electromotive force detection coil 53 in such a manner to supply a driving current in the driving coil 51 at a timing of the driving frequency while performing a feedback control. This absorbs variations in driving frequency of each movable mirror, thereby achieving the most efficient (the minimum power consumption) driving of the movable mirror 37.

In the movable mirror driving mechanism 31 for bar code reader, the coil 41 for interlinking with magnetic flux of the magnet 39 is a dual coil comprising the driving coil 51 for oscillating the movable mirror and the electromotive force detection coil 53 integrally wound with the driving coil 51 and having a smaller wire diameter and a larger number of turns than the driving coil 51. This helps to optimize the two respective coils performing different functions. In other words, the driving coil 51 has a larger wire diameter and a smaller number of turns than the driving coil 51 so that a larger current can be supplied through the coil than the electromotive force detection coil 53. On the contrary, the electromotive force detection coil 53 has a smaller wire diameter and a larger number of turns than the driving coil 51 so that a larger electromotive force can be developed. As a result, it is possible to achieve higher efficiency and miniaturization of the coil 41 as a whole by eliminating waste of the coil as compared to a conventional single coil commonly used for the two functions.

Additionally, in order to detect electromotive force, the electromotive force detection coil 53 required to have a larger number of turns than the driving coil 51 is wound at a portion inner than the driving coil 51, thereby enhancing detection efficiency. In other words, the total volume of the coil can be decreased than the case of winding the driving coil 51 at a portion inner than the electromotive force detection coil 53 because the number of turns of the electromotive force detection coil 53 can be decreased. This helps to minimize the coil 41 as a whole.

An example of optimizing the coils to be used in the movable mirror driving mechanism for bar code reader according to the present invention is shown in the following Table-1:

TABLE 1

| | wire diameter | number of turns |
|---|---|---|
| driving coil | 0.05 mm | 290 turns |
| electromotive | 0.04 mm | 612 turns |
| force detection | | |
| coil | | |

In a case of driving the movable mirror of, e.g., 0.047 gram at 20 Hz according to the present invention, the driving coil is made by winding 0.05 mm diameter wire 290 turns while the electromotive force detection coil is made by winding 0.04 mm diameter wire 612 turns to obtain the optimum result.

Although the above embodiment used the dual coil 41 comprising the driving coil 51 and the electromotive force detection coil 53 separated from each other, it is possible to configure the movable mirror driving mechanism for bar code reader using a single coil formed with a center tap. The driving coil for oscillating the movable mirror is located at one side of the center tap while the electromotive force detection coil is located at the other side of the center tap.

In this alternative embodiment, the driving coil has a smaller number of turns than the electromotive force detection coil so that a larger current is supplied through the driving coil to obtain a larger driving force. On the other hand, the electromotive force detection coil has a larger number of turns than the driving coil to develop a larger electromotive force, thereby increasing efficiency of the coil as compared to the use of a single coil performing the two functions. This alternative embodiment is capable of easily providing coils having optimum number of turns by continuously winding a single wire diameter and providing the center tap at a suitable location.

Although the invention has been described in its preferred form with a certain degree of particularity, obviously many changes and variations are possible therein. It is therefore to be understood that the present invention may be practiced otherwise than as specifically described herein without departing from the scope and the sprit thereof.

What is claimed is:

1. A movable mirror driving mechanism for bar code reader in which a laser beam emitted from a light emitting element is reflected off a movable mirror, said movable mirror is oscillated for making the laser beam scan across an object to be scanned and light returned from the object to be scanned is reflected off said movable mirror to be received by a light receiving element, said mechanism comprising:
said movable mirror supported to oscillate about a pivot;
a magnetic member firmly attached to said movable mirror; and
a coil for interlinking with magnetic flux of said magnetic member, wherein:
said coil is a dual coil comprising a driving coil for oscillating said movable mirror and an electromotive force detection coil integrally wound with said driving coil and having a smaller wire diameter and a larger number of turns than said driving coil.

2. The movable mirror driving mechanism for bar code reader according to claim 1, wherein said driving coil is wound outside said electromotive force detection coil.

3. A movable coil driving mechanism for bar code reader in which a laser beam emitted from a light emitting element is reflected off a movable mirror, said movable mirror is oscillated to make the laser beam scan across an object to be scanned and light returned from the object to be scanned is reflected off said movable mirror to be received by a light receiving element, comprising:
said movable mirror supported to oscillate about a pivot;
a magnetic member firmly attached to said movable mirror; and
a coil interlinking with magnetic flux of said magnetic member, wherein:
said coil is formed with a center tap for separating a driving coil for oscillating said movable mirror and an electromotive force detection coil.
